(19) United States
(12) Patent Application Publication
(10) Pub. No.: US 2014/0056490 A1
(43) Pub. Date: Feb. 27, 2014

(54) IMAGE RECOGNITION APPARATUS, AN IMAGE RECOGNITION METHOD, AND A NON-TRANSITORY COMPUTER READABLE MEDIUM THEREOF

(71) Applicant: KABUSHIKI KAISHA TOSHIBA, Tokyo (JP)

(72) Inventor: Tomokazu Kawahara, Kanagawa-ken (JP)

(73) Assignee: Kabushiki Kaisha Toshiba, Tokyo (JP)

(21) Appl. No.: 13/856,146

(22) Filed: Apr. 3, 2013

(30) Foreign Application Priority Data
Aug. 24, 2012 (JP) 2012-185288

(51) Int. Cl. G06K 9/00

(52) U.S. Cl. CPC G06K 9/00281
USPC 382/118

(57) ABSTRACT

According to one embodiment, an image recognition apparatus includes an acquisition unit, a detection unit, an extraction unit, a calculation unit, and a matching unit. The acquisition unit is configured to acquire an image. The detection unit is configured to detect a face region of a target person to be recognized from the image. The extraction unit is configured to extract feature data of the face region. The calculation unit is configured to calculate a confidence degree of the feature data, based on a size of the face region. The matching unit is configured to calculate a similarity between the target person and each of a plurality of persons by matching the feature data with respective feature data of the plurality of persons previously stored in a database, and to recognize the target person from the plurality of persons, based on the similarities and the confidence degree.

### CROSS-REFERENCE TO RELATED APPLICATION

This application is based upon and claims the benefit of priority from Japanese Patent Application No. 2012-185288, filed on Aug. 24, 2012; the entire contents of which are incorporated herein by reference.

### FIELD

Embodiments described herein relate generally to an image recognition apparatus, an image recognition method, and a non-transitory computer readable medium thereof.

### BACKGROUND

An image recognition apparatus for recognizing a target person is well known. As to the image recognition apparatus, from an input image on which the target person (recognition target) is photographed, a feature of the target person's face is quantized and extracted. By comparing this feature with a feature of respective faces of a plurality of persons previously registered in a database, the target person is recognized.

In the image recognition apparatus of conventional technique, from a facial direction or wearing things of the target image in the input image, or an illumination environment, a confidence degree each of a plurality of features used for face recognition is decided. By recognizing the target person based on the confidence degree and each feature, the recognition accuracy is raised to some extent.

However, in this image recognition apparatus, due to a size of the target person's face in the input image, the recognition accuracy cannot be sufficiently raised.

### BRIEF DESCRIPTION OF THE DRAWINGS

FIG. 1 is a block diagram of an image recognition apparatus 1 according to a first embodiment.

FIG. 2 is a flow chart of processing of the image recognition apparatus 1.

FIG. 3 is a schematic diagram to explain a method for extracting a feature of a face region by an extraction unit in FIG. 1.

FIG. 4 is one example of a confidence table correspondingly storing a size of the face region and the confidence degree of feature data.

FIG. 5 is one example of matching data.

FIG. 6 is a block diagram of an image recognition apparatus 2 according to a second embodiment.

FIG. 7 is one example of a frequency image visualizing space frequency components of the face region.

FIG. 8 is one example of a filter table.

FIG. 9 is one example of each filter visualized.

FIG. 10 is a flow chart of processing of an extraction unit 23 and a calculation unit 24 in FIG. 6.

FIG. 11 is a block diagram of one example of respective hardware components of the image recognition apparatuses 1 and 2.

### DETAILED DESCRIPTION

According to one embodiment, an image recognition apparatus includes an acquisition unit, a detection unit, an extraction unit, a calculation unit, and a matching unit. The acquisition unit is configured to acquire an image. The detection unit is configured to detect a face region of a target person to be recognized from the image. The extraction unit is configured to extract feature data of the face region. The calculation unit is configured to calculate a confidence degree of the feature data, based on a size of the face region. The matching unit is configured to calculate a similarity between the target person and each of a plurality of persons by matching the feature data with respective feature data of the plurality of persons previously stored in a database, and to recognize the target person from the plurality of persons, based on the similarities and the confidence degree.

Various embodiments will be described hereinafter with reference to the accompanying drawings.

### The First Embodiment

An image recognition apparatus 1 of the first embodiment can be used for a security system using a monitor camera. As to the image recognition apparatus 1, a target Person's face photographed in an input image is compared with matching data of respective faces of a plurality of persons previously stored in a database. Based on this comparison result, the target person is recognized.

In the image recognition apparatus 1, first, a size of a face region of the target person photographed in the input image is calculated, and feature data in the face recognition is extracted. Next, based on the size of the face region, a confidence degree of the feature data (used for recognition) is calculated. Last, by using the confidence degree and the feature data, the target person is recognized. As a result, the target person can be recognized with high accuracy.

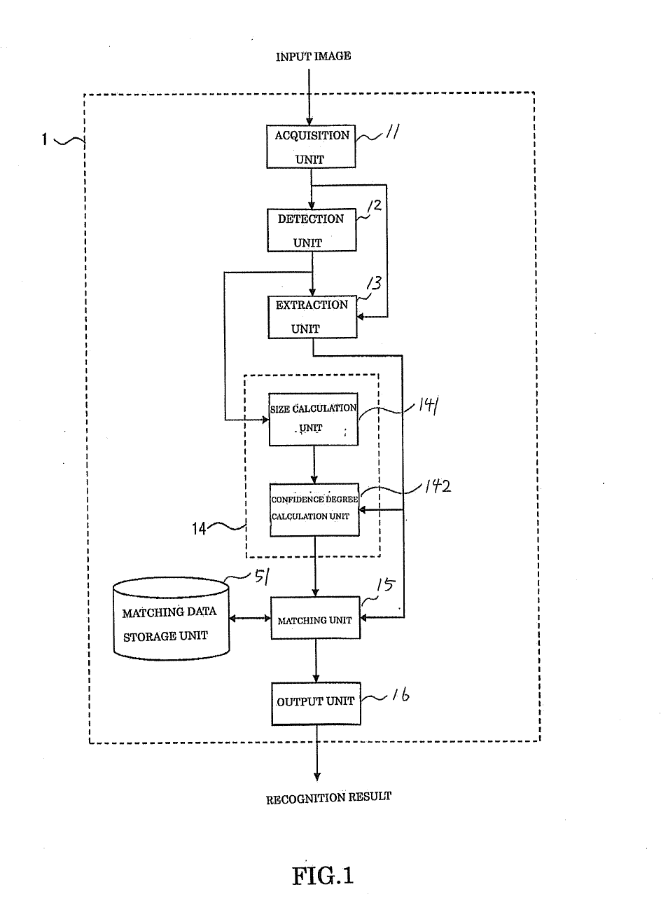

FIG. 1 is a block diagram of the image recognition apparatus 1 according to the first embodiment. The image recognition apparatus 1 includes an acquisition unit 11, a detection unit 12, an extraction unit 13, a calculation unit 14, a matching unit 15, an output unit 16, and a matching data storage unit 51. The calculation unit 14 includes a size calculation unit 141 and a confidence degree calculation unit 142.

The acquisition unit 11 acquires an input image. For example, the input image may be photographed by a monitor camera. Furthermore, the input image may be a static image or a moving image.

The detection unit 12 detects a face region of a target person photographed in the input image. The target person may be one or a plurality of persons. For example, by scanning a rectangle region to detect the face region on the image, the detection unit 12 may detect the face region using Haar-like feature based on a difference of averaged brightness of the rectangle region (Refer to JP-A 2006-268825 (Kokai)). Alternatively, by a template matching using a face model image to detect the face region, the detection unit may detect the face region.

The extraction unit 13 extracts feature data of the face region. Here, the extraction unit 13 segments the face region from the input image, and normalizes the face region to a predetermined size by enlargement/reduction or affine transformation. As the reason why normalization is performed, based on a size of the face region of the target person, dimensions (the number of elements) of feature data as an extracted vector changes. Accordingly, the dimensions of the vector of respective feature data must be equalized for matching by the matching unit 15 (explained afterwards).

The size calculation unit 141 calculates a size of the face region detected.

Based on the size of the face region, the confidence degree calculation unit 142 calculates a confidence degree of respective feature data. Here, the confidence degree of feature data represents which degree the feature data can be confided, when the matching unit 15 (explained afterwards) matches using the feature data. Detail explanation thereof will be explained.

The matching data storage unit 51 previously stores matching data. The matching data correspondingly represents a person ID to identify each of a plurality of persons and feature data of a face region of the person. The matching data may be a table format. Furthermore, the feature data included in the matching data and feature data extracted by the extraction unit 13 are previously corresponded in order to be mutually compared.

By referring to the matching data storage unit 51, the matching unit 15 compares respective feature data extracted from the face region of the target person with the matching data stored, and calculates a feature similarity as a degree of similarity between two feature data compared. Based on the feature similarity and the confidence degree (calculated by the confidence degree calculation unit 142), the matching unit 15 calculates a person similarity as a degree of similarity between the target person and each person registered in the matching data.

The matching unit 15 extracts a person ID of which the person similarity is high from the matching data storage unit 51. The person ID extracted from the matching data storage unit 51 is a recognition result in the first embodiment. Moreover, the matching unit 15 may extract the person ID having the highest person similarity, or may extract a plurality of person IDs in order of higher person similarity from the highest person similarity. Briefly, the matching unit 15 may set the recognition result in response to a request from a user.

The output unit 16 outputs the recognition result. For example, the output unit 16 outputs the recognition result to a display, a speaker, or another device to execute data processing using the recognition result.

The acquisition unit 11, the detection unit 12, the extraction unit 13, the size calculation unit 141, the confidence degree calculation unit 142, the matching unit 15, and the output unit 16, may be realized by a CPU (Central Processing Unit) and a memory used thereby. Furthermore, the matching data storage unit 51 may be realized by any of a magnetic storage device, an optical storage device, or an electric storage device, such as a HDD (Hard Disk Drive), a SSD (Solid State Drive), a ROM (Read Only Memory), or a memory card.

Furthermore, the matching data storage unit 51 may be composed by one or a plurality of servers on a network. As a result, the image recognition apparatus 1 can be implemented as a system using a cloud computing.

Thus far, component of the image recognition apparatus 1 is already explained.

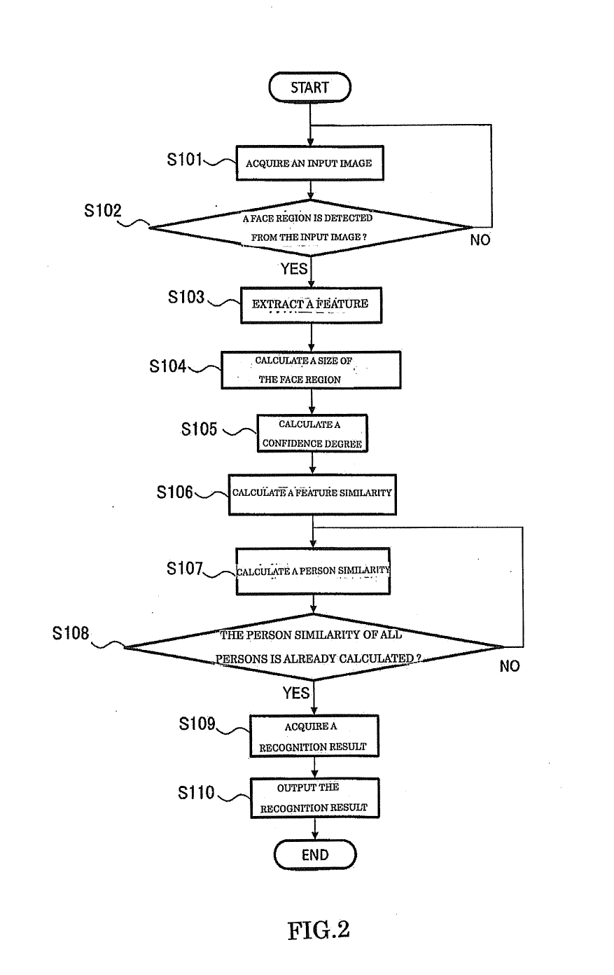

FIG. 2 is a flow chart of processing of the image recognition apparatus 1. Processing shown in the flow chart of FIG. 2 is performed whenever the acquisition unit 11 acquires an input image.

First, the acquisition unit 11 acquires an input image (S101). The acquisition unit 11 supplies the input image to the detection unit 12 and the extraction unit 13.

The detection unit 12 decides whether to detect a face region of a target person photographed in the input image (S102).

If the face region is not detected (No at S102), processing is transited to S101. Here, the acquisition unit 11 acquires a next input image.

If the face region is detected (Yes at S102), the extraction unit 13 extracts a plurality of feature data of the face region (S103). In this case, the detection unit 12 supplies position information of the target person in the input image to the extraction unit 13 and the size calculation unit 141. In the first embodiment, a shape of the face region is rectangle. Accordingly, the detection unit 12 may supply respective coordinates of a left upper point and a right lower point in the face region to the extraction unit 13. Then, the extraction unit 13 extracts a plurality of feature data from respective a region corresponding to the position information in the input image.

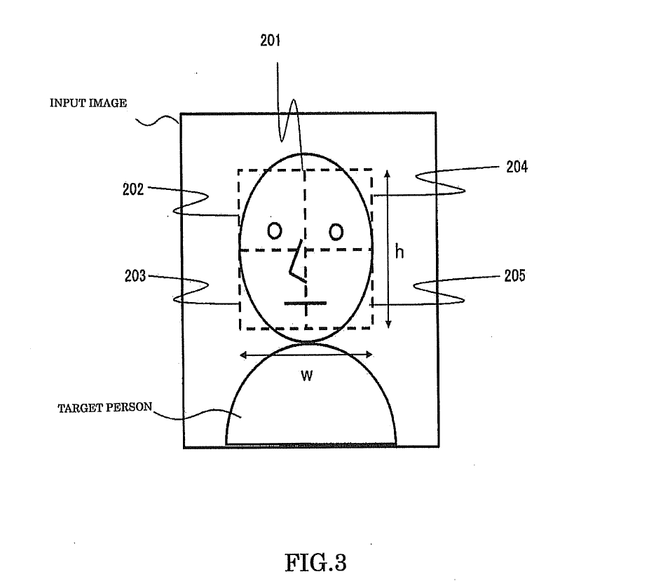

FIG. 3 is a schematic diagram to explain a method for extracting feature data of the face region by the extraction unit 13. In the input image, a rectangle 201 represents a face region detected by the detection unit 12. Rectangles 202-205 are each rectangle quartered from the rectangle 201.

In the first embodiment, feature data is extracted from the rectangle 201, and quartered rectangles 202-205. In order to equalize dimensions of feature data extracted, each rectangle is enlarged or reduced to a rectangle image having a predetermined size. Alternatively, affine transformation is executed to each rectangle. Briefly, as to a vector of which elements are a brightness of each pixel of the rectangle image, a length of the vector is normalized to “1”. This normalized vector is feature data.

Alternatively, by performing a Sobel filter or a Gabor filter to pixels of the face region in an image, a vector of which elements are a brightness of each pixel of the image may be feature data. Furthermore, whitening transformation or linear transformation may be performed to the feature data. Furthermore, before extracting the feature, normalized processing to generate a frontal face image using three-dimensional face model may be performed.

Here, in technical field of face recognition, in general, recognition accuracy by respective feature data extracted is different for a size of the face region. For example, if a size of the face region in the input image is large, details of information about the face region can be discriminated. Accordingly, recognition accuracy of feature data extracted from rectangles 202˜205 is higher than that of feature data extracted from a rectangle 201.

On the other hand, if a size of the face region in the input image is small, details of information about the face region is lost. Accordingly, recognition accuracy of the feature data falls. Briefly, the recognition accuracy of respective feature data extracted changes by the size of the face region. Moreover, in the first embodiment, assume that the number of feature data extracted from one face region is N.

The extraction unit 13 supplies the feature data to the confidence degree calculation unit 142 and the matching unit 15.

Based on the position information supplied, the size calculation unit 141 calculates a size of the face region detected (S104).

In FIG. 3, “w” represents a lateral width of the face rectangle 201, and “h” represents a vertical width of the face rectangle 201. By following an equation (1), the size calculation unit 141 calculates a size “s” of the face region as an average of the lateral width “w” and the vertical width “h”.

$$s = \frac{w + h}{2} \qquad ( 1 )$$

The size calculation unit 141 supplies the size of the face region to the confidence degree calculation unit 142.

Based on the size of the face region, the confidence degree calculation unit 142 calculates a confidence degree of respective feature data (S105). The confidence degree ri (i=1, . . . , N) of respective feature data is defined by an equation (2).

$${r}_{i} = {c}_{i} \times exp ( - \frac{{( s - {a}_{i} )}^{2}}{{b}_{i}} ) \qquad ( 2 )$$

Here, “aᵢ, bᵢ, cᵢ” are coefficients to calculate a confidence degree of i-th (i=1, . . . , N) feature data. Briefly, in the equation (2), the more a face size s closes to aᵢ, the larger the confidence degree rᵢ becomes. On the other hand, the more the face size s deviates from aᵢ, the smaller the confidence degree rᵢ becomes. A level to become larger is determined by bᵢ, and cᵢ is a value to adjust a maximum of the confidence degree. More, here, the face size is calculated using an average (equation (1)) of the lateral width w and the vertical width h. However, a maximum or a minimum thereof may be used. Furthermore, a function of the lateral width w and the vertical width h as an equation (3) may be used.

$${r}_{i} = {c}_{i} \times exp ( - \frac{{( w - {a}_{i} )}^{2}}{{b}_{i}} - \frac{{( h - {d}_{i} )}^{2}}{{e}_{i}} ) \qquad ( 3 )$$

Here, “a₁, b₁, cᵢ, dᵢ, eᵢ” are coefficients to calculate a confidence degree of i-th (i=1, . . . , N) feature data.

Furthermore, by detecting not a size of the face region but facial feature points such as an eye, a nostril, or both ends of a mouth, the confidence degree rᵢ of respective feature data may be calculated using coordinates of facial feature points or a distance between two facial feature points. As a method for detecting facial feature points, for example, the method disclosed in JP-A 2008-146329 (Kokai) may be used. As the distance between two facial feature points, for example, a distance between both eyes may be used.

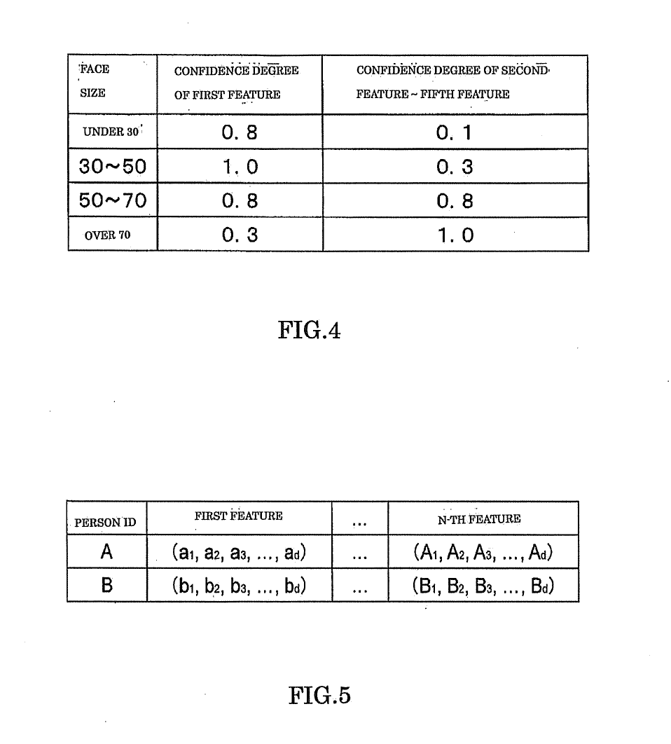

Furthermore, the confidence degree rᵢ of respective feature data may be determined by not the equation but a confidence table previously stored. FIG. 4 is one example of the confidence table correspondingly storing a size of the face region and a confidence degree of feature data. In the confidence table of FIG. 4, for example, if the size is “25”, the confidence degree of the first feature is “0.8”, and the confidence degree of the second feature is “0.1”.

The confidence degree calculation unit 142 supplies the confidence degree to the matching unit 15.

By referring to the matching data storage unit 51, the matching unit 15 compares respective feature data extracted from the face region of the target person with a feature of each person's face stored in matching data, and calculates a feature similarity between the target person and each person' face stored in the matching data.

FIG. 5 is one example of the matching data. As shown in FIG. 5, in the matching data of the first embodiment, as for each of a plurality of persons, a person ID as an identifier of each person and feature data of the person's face are corresponded.

In FIG. 5, as to a person having the person ID “A”, the first feature data (a₁, a₂, . . . , a_{d})˜the N-th feature data (A₁, A₂, . . . , A_{N}) extracted from a face image of this person are corresponded. Furthermore, as to a person having the person ID “B”, the first feature data (b₁, b₂, . . . , b_{d})˜the N-th feature data (B₁, B₂, . . . , B_{d}) extracted from a face image of this person are corresponded. Here, “d” is a dimension of feature data (vector).

In the first embodiment, the matching unit 15 calculates an inner product between respective feature data extracted from the face region of the target person and respective feature data of a face region of a person included in the matching data, as a feature similarity of respective feature data. The respective feature data is a vector of which length is “1”. Accordingly, the inner product is equivalent to a simple similarity. Briefly, the feature similarity sᵢ is represented as an equation (4).

sᵢ=a₁x₁+a₂x₂+ . . . +a_{d}x_{d} (4)

In the equation (4), “(x₁, . . . , x_{d})” represents i-th feature data extracted by the extraction unit 13, and “(a₁, . . . , a_{d})” represents i-th feature data of a person having the person ID “A” stored in the matching data storage unit 51.

Based on the feature similarity and the confidence degree (calculated by the confidence degree calculation unit 142), the matching unit 15 calculates a person similarity as a similar level between the target person and each person stored in the matching data storage unit 51 (S107).

Briefly, in the first embodiment, based on the similarities s₁˜s_{N} of respective feature data and the confidence degree r₁˜r_{N} acquired by the calculation unit 14, the matching unit 15 calculates the person similarity “s” as a similarity between the target person and a person included in the matching data. This similarity “s” is represented as an equation (5).

s=r₁s₁+r₂s₂+ . . . +r_{N}s_{N} (5)

The matching unit 15 decides whether the person similarity of all persons included in the matching data (S108).

If the person similarity of at least one person is not calculated yet (No at S108), processing is transited to S107. In this case, the matching unit 15 calculates a person similarity of a person of which the person similarity is not calculated yet.

If the person similarity of all persons included in the matching data is already calculated (Yes at S108), processing is transited to S109. In this case, the matching unit 15 acquires the person ID of which the person similarity is the highest from the matching data storage unit 51, as a recognition result. In the first embodiment, the matching unit 15 extracts the person ID having the highest person similarity from the matching data storage unit 51.

The output unit 16 outputs the recognition result (S110). In the first embodiment, the output unit 16 outputs the person ID of a person having the highest person similarity and the person similarity thereof.

However, the output method by the output unit 16 is not limited to this. The output unit 16 may output person IDs of which person similarities are larger than a predetermined threshold, and the person similarity corresponding to respective person IDs. In this case, if the person similarity larger than the predetermined threshold does not exist, information representing there are no persons concerned among persons included in the matching data may be output. Alternatively, person IDs of all persons (included in the matching data) and the person similarity corresponding to each person ID may be output.

Thus far, processing of the image recognition apparatus 1 is already explained.

Moreover, in the first embodiment, the face region is explained as a rectangle. However, a shape of the face region is not limited to this. For example, the face region may be a circle, an ellipse, or a polygon. If the face region is a circle, the detection unit 12 may supply a center and a radius of the circle, as position information to the extraction unit 13. If the face region is an ellipse, the detection unit 12 may supply coordinates of a center, a major axis and a minor axis of the ellipse, as position information to the extraction unit 13. If the face region is a polygon, the detection unit 12 may supply coordinates of each peak of the polygon, as position information to the extraction unit 13.

According to the first embodiment, a target person is recognized by using the confidence degree calculated based on a size of the face region, and the feature data. As a result, the target person cannot be accurately recognized.

### (Modification)

In the first embodiment, after the extraction unit 13 extracts respective feature data, the calculation unit 14 calculates the confidence degree of respective feature data. However, this processing sequence may be reverse. Furthermore, in this case, by using the confidence degree, the extraction unit 13 may select feature data to be extracted. Briefly, the extraction unit 13 may extract only feature data of which the confidence degree is larger than a predetermined threshold. Furthermore, by aligning respective feature data in order of larger confidence degree, feature data of which the confidence degree is higher in rank may be extracted. Furthermore, the feature data of which the confidence degree is “0” may be not extracted. As a result, the processing can be quickly performed.

### The Second Embodiment

As to an image recognition apparatus 2 of the second embodiment, frequency conversion is performed to a face region of the target person photographed in the input image. Then, a space frequency component of the face region is extracted, and a confidence degree of feature data is calculated from the space frequency component. This feature is different from the first embodiment. The space frequency element is represented as a vector. Briefly, in the second embodiment, each component of the space frequency component is feature data. Hereinafter, component units different from the first embodiment are explained.

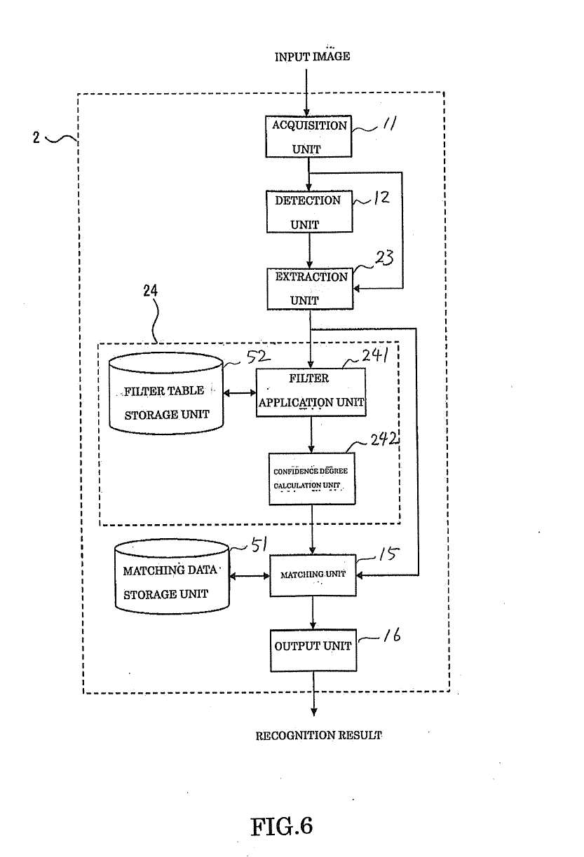

FIG. 6 is a block diagram of the image recognition apparatus 2. In the image recognition apparatus 2, in comparison with the image recognition apparatus 1, the extraction unit 13 is replaced with an extraction unit 23, and the calculation unit 14 is replaced with a calculation unit 24. The calculation unit 24 includes a filter application unit 241, a confidence degree calculation unit 242, and a filter table storage unit 52.

The extraction unit 23 extracts a frequency component of a face region (detected by the detection unit 12) in the input image. For example, as for the face region (rectangle 201) of the target person shown in FIG. 3, the extraction unit 23 performs Two-dimensional Fourier Transform, and extracts a space frequency component. In this case, the extraction unit 23 normalizes the face region to a predetermined size, and extracts the frequency component of the face region.

Based on a size of the face region in the input image, a band of the space frequency component extracted by the extraction unit 23 is different. For example, if a size of the face region is large, a band of high frequency in the space frequency component becomes large. If a size of the face region is small, a band of low frequency in the space frequency component becomes large.

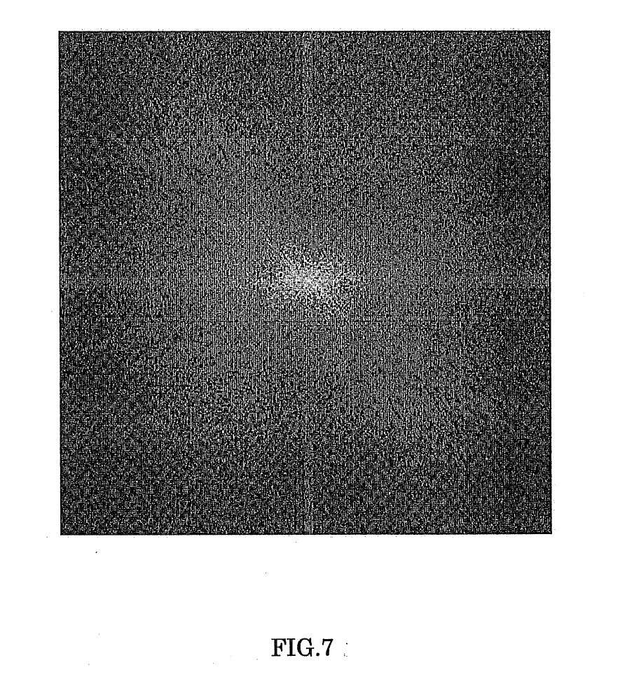

FIG. 7 is a frequency image visualizing the space frequency component of the face region. In the frequency image of FIG. 7, a center part represents an intensity of a low frequency component, and an outer part represents an intensity of a high frequency component. Two-dimensional Fourier Transform includes, except for Fourier Transform, Discrete Fourier Transform, Fast Fourier Transform, and Discrete Cosine Transform.

The filter table storage unit 51 stores a filter table. The filter table correspondingly represents a filter used for the confidence degree calculation unit 242 (explained afterwards) to calculate a confidence degree, and feature data corresponding to the filter.

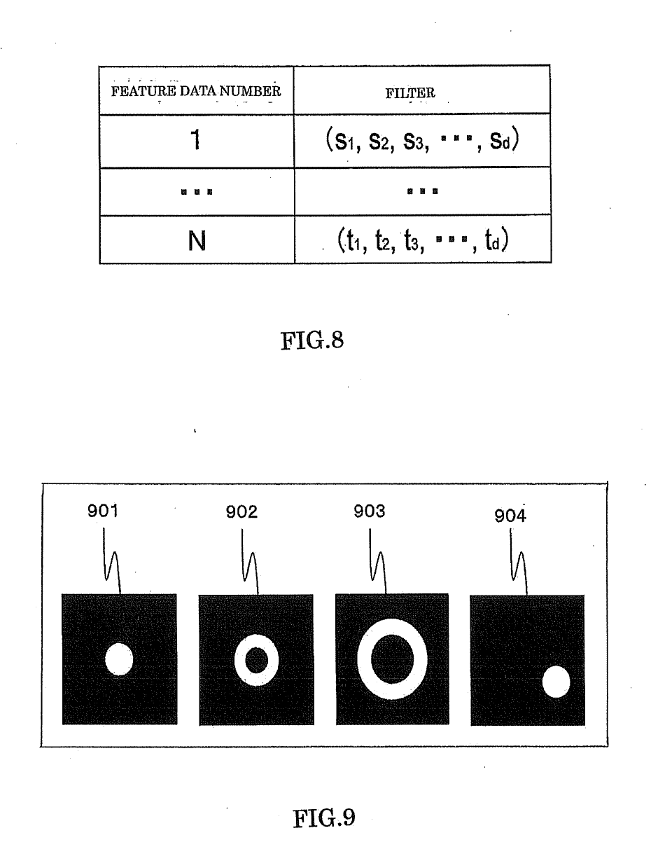

FIG. 8 is one example of the filter table. A filter corresponding to feature data is represented as a vector. FIG. 9 is one example of each filter visualized. The filter application unit 241 applies filters shown in FIG. 9 to the space frequency component of the face region (extracted by the extraction unit 23). Briefly, the frequency component and the filter are regarded as two vectors having the same dimension and aligning numerical values. The filter application unit 241 calculates a vector (applied vector) having each component as a product between two corresponding components of the two vectors. In the second embodiment, this calculation means application of the filter.

In FIG. 9, the filter application unit 241 applies a filter 901 to the space frequency component of the face region, and acquires a low frequency component of the face region. The filter application unit 241 applies a filter 902 to the space frequency component of the face region, and acquires a medium frequency component of the face region. The filter application unit 241 applies a filter 903 to the space frequency component of the face region, and acquires a high frequency component of the face region.

Furthermore, the filter application unit 241 may apply a filter 904 to the space frequency component of the face region. The filter 904 is a Gabor filter to simultaneously indicate a frequency and a direction of cycle, and acquire the frequency component thereof.

Moreover, by applying a principal component analysis or a linear discriminant analysis to the frequency component extracted from a plurality of face regions, the filter application unit 241 may apply this acquired vector as a filter.

From the applied vector acquired by the filter application unit 241, the confidence degree calculation unit 242 calculates a confidence degree of feature data (each component of the space frequency component). In the second embodiment, the confidence degree of respective feature data is a length of the applied vector.

Based on a size of the face region in the input image, a band of the space frequency component extracted by the extraction unit 23 is different. Accordingly, the confidence degree calculated by the confidence degree calculation unit 24 also changes based on the size of the face region. For example, if the size of the face region is large, the confidence degree of feature data acquired by filter processing to extract a band of high frequency component becomes high. If the size of the face region is small, the confidence degree of feature data acquired by filter processing to extract a band of low frequency component becomes high.

Moreover, the confidence degree of respective feature data may be a square of a length of the applied vector. Briefly, if the applied vector is longer, the feature data (acquired by a filter corresponding to the applied vector) includes the larger number of components.

Furthermore, after the confidence degree of respective feature data is calculated, by dividing the respective feature data with a sum of the respective feature data so that the sum is equal to “1”, this division result may be the confidence degree of the respective feature data again. Furthermore, an average or a product of this confidence degree and a confidence degree acquired from a size of the face region may be the confidence degree of the respective feature data again.

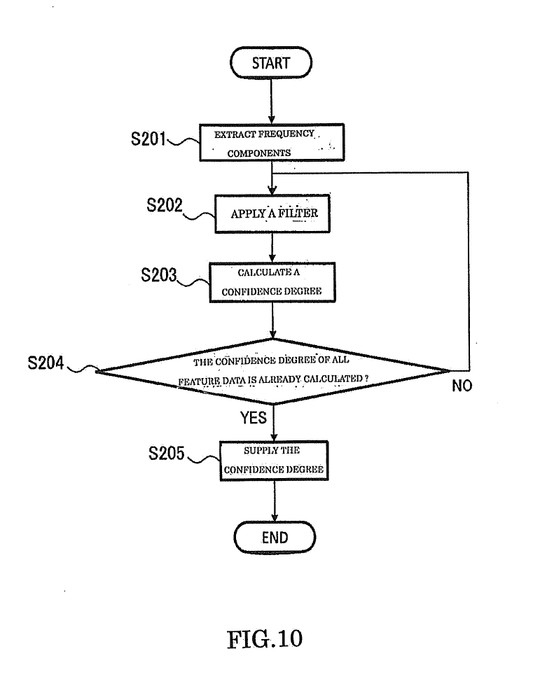

FIG. 10 is a flow chart of processing of the extraction unit 23 and the calculation unit 24.

The extraction unit 23 extracts frequency components of a face region detected by the detection unit 12 from the input image (S201). The filter application unit 241 selects a filter stored in the filter table storage unit 52 sequentially, and applies the filter to a space frequency component of the face region extracted by the extraction unit 23 (S202). The confidence degree calculation unit 242 calculates a confidence degree of feature data from an applied vector acquired by the filter application unit 241 (S203).

The confidence degree calculation unit 242 decides whether the confidence degree of all feature vectors is already calculated (S204). If the confidence degree of at least one feature data is not calculated yet (No at S204), processing is transited to S202. If the confidence degree of all feature vectors is already calculated (Yes at S204), the confidence degree calculation unit 242 supplies the confidence degree of respective feature data to the matching unit 15.

Thus far, processing of the extraction unit 23 and the calculation unit 24 is already explained.

Moreover, the matching unit 15 uses the space frequency component as feature data, and performs the same processing as the first embodiment. In this case, feature data included in matching data (stored in the matching data storage unit 51) is previously corresponded to feature data extracted by the extraction unit 23 so as to be comparable.

According to the second embodiment, by not only using a size of the face region in the input image but also performing above-mentioned processing, a resolution of the face region and a blurring of the input image can be taken into consideration. As a result, a person photographed in the image can be accurately recognized.

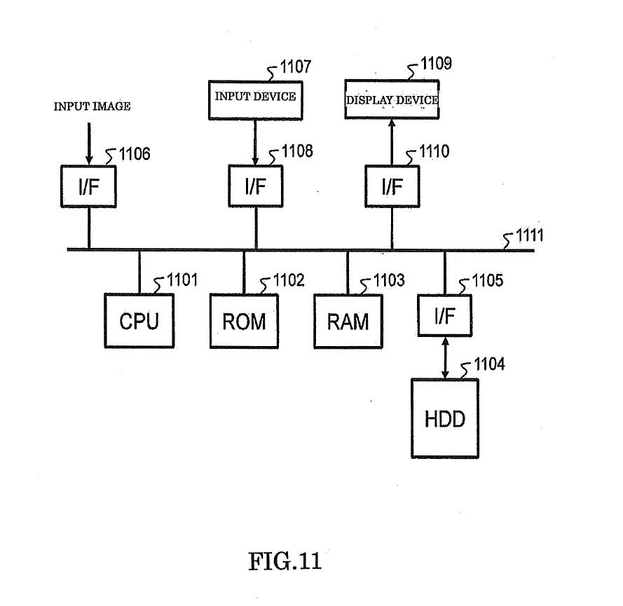

FIG. 11 is a block diagram of a hardware component of the image recognition apparatuses 1 and 2. As shown in FIG. 11, the image recognition apparatuses 1 and 1 includes a CPU 1101, a ROM 1102, a RAM 1103, an HDD 1104, an I/F 1105, an I/F 1106, an input device 1107, an I/F 1108, a display device 1109, an I/F 1110, and a bus 1111. The ROM 1102 stores a recognition program to recognize a face and an object from the image. The HDD 1104 stores a recognition table. The I/F 1105 is an interface with the HDD 1104. The I/F 1106 is an interface to input an image. The input device 1107 is a mouse or a keyboard. The I/F 1108 is an interface with the input device 1107. The I/F 1110 is an interface with the display device 1109. This hardware component utilizes a general purpose computer. Moreover, the CPU 1101, the ROM 1102, the RAM 1103, the I/F 1105, the I/F 1106, the I/F 1108 and the I/F 1110, are mutually connected via the bus 1111.

In the image recognition apparatuses 1 and 2, the CPU 1101 reads a recognition program from the ROM 1102 to the RAM 1103, and executes the recognition program. Accordingly, above-mentioned each unit (the detection unit, the calculation unit, the extraction unit, the matching unit) is realized on the computer. As a result, by using matching data stored in the HDD 1104, a face region of a target person included in the input image is recognized.

Moreover, the recognition program may be stored in the HDD 1104. Moreover, the recognition program may be stored as an installable format or an executable format in a computer readable storage medium such as a CD-ROM, a CD-R, a memory card, a DVD or a flexible disk (FD), and provided therefrom. Moreover, the recognition program may be stored in the computer connected with a network such as an Internet, and provided by downloading via the network. Furthermore, the recognition program may be provided or distributed via the network such as the Internet. Furthermore, the recognition table may be stored in the ROM 1102. Furthermore, the image may be stored in the HDD 1104, and inputted therefrom via the I/F 1105.

As mentioned-above, according to the image processing apparatuses 1 and 2, a confidence degree of feature data is calculated based on a size of a face region photographed in the input image, and a recognition result of respective feature data is unified based on the confidence degree. Accordingly, fall of face-recognition accuracy by the size or a resolution of the face region can be suppressed. Furthermore, according to the second embodiment, if an enlarged face image having a low resolution is inputted, or if a size of a blurred face region is large, a confidence degree is calculated from frequency components thereof. Accordingly, by using the confidence degree, fall of face-recognition accuracy can be suppressed.

While certain embodiments have been described, these embodiments have been presented by way of examples only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image recognition apparatus comprising:
an acquisition unit configured to acquire an image;
a detection unit configured to detect a face region of a target person to be recognized from the image;
an extraction unit configured to extract feature data of the face region;
a calculation unit configured to calculate a confidence degree of the feature data, based on a size of the face region; and
a matching unit configured to calculate a similarity between the target person and each of a plurality of persons by matching the feature data with respective feature data of the plurality of persons previously stored in a database, and to recognize the target person from the plurality of persons, based on the similarities and the confidence degree.

2. The apparatus according to claim 1, wherein
the extraction unit extracts a frequency component of the face region of which the size is normalized, and
the calculation unit calculates the confidence degree of each band of the frequency component.

3. The apparatus according to claim 2, wherein
the calculation unit calculates the confidence degree based on dimensions of a component of the each band extracted by a filter for extracting the component of the each band.

4. The apparatus according to claim 1, wherein
the extraction unit selects the feature data to be extracted, based on the confidence degree.

5. The apparatus according to claim 4, wherein
the extraction unit extracts the feature data of which the confidence degree is larger than a predetermined threshold.

6. An image recognition method comprising:
acquiring an image;
detecting a face region of a target person to be recognized from the image;
extracting feature data of the face region;
calculating a confidence degree of the feature data, based on a size of the face region;
calculating a similarity between the target person and each of a plurality of persons by matching the feature data with respective feature data of the plurality of persons previously stored in a database; and
recognizing the target person from the plurality of persons, based on the similarities and the confidence degree.

7. A non-transitory computer readable medium for causing a computer to perform an image recognition method, the method comprising:
acquiring an image;
detecting a face region of a target person to be recognized from the image;
extracting feature data of the face region;
calculating a confidence degree of the feature data, based on a size of the face region;
calculating a similarity between the target person and each of a plurality of persons by matching the feature data with respective feature data of the plurality of persons previously stored in a database; and
recognizing the target person from the plurality of persons, based on the similarities and the confidence degree.
